(19) United States
(12) Patent Application Publication
(10) Pub. No.: US 2008/0077476 A1
(43) Pub. Date: Mar. 27, 2008

(54) Systems and methods for determining markets to sell merchandise

(75) Inventors: James P. McElhiney, Cambridge, MA (US); Rousseau Aurelien, Brookline, MA (US); Shari D. Silvers, Boston, MA (US); Robert J. McCarthy, Wakefield, MA (US); Israel Y. Ganot, Needham, MA (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Second Rotation Inc.

(21) Appl. No.: 11/903,255

(22) Filed: Sep. 21, 2007

Related U.S. Application Data
(60) Provisional application No. 60/846,778, filed on Sep. 22, 2006.

(51) Int. Cl. G06Q 30/00

(52) U.S. Cl. 705/10

(57) ABSTRACT

Systems and methods for determining at least one market to sell a trade-in product are disclosed herein. A system for determining at least one market to sell a trade-in product includes a dynamic pricing guide that determines an initial value for the trade-in product; a product profiler that provides product intelligence; a product profile manager tool that delivers real-time access to product information and collects product information; a trade-in manager tool that accepts, processes and manages the trade-in of the trade-in product; and an automatic merchandising agent for analyzing the product intelligence.

### RELATED APPLICATIONS

This application claims the benefit of U.S. Provisional Application Ser. No. 60/846,778, filed on Sep. 22, 2006, the entirety of which is hereby incorporated herein by reference for the teachings therein.

### FIELD

The embodiments disclosed herein relate to trading-in and selling merchandise using electronic commerce, and more particularly to systems and methods for determining markets to sell merchandise.

### BACKGROUND

The rapid pace of product innovation has slashed the life cycles of current generational products. Increasing consumer brand loyalty has shaped a brand-centric economy. Consumer affluence has sped the adoption rate to the latest and greatest products. These trends have resulted in piling inventories of pre-owned durable goods. Simultaneously, e-commerce and the online trading culture have revolutionized the way we distribute, buy, sell, market, and service products. Online marketplaces, available anywhere and anytime, enable individuals and businesses to connect and trade both new and used goods. The result is a vibrant global marketplace with vast potential to facilitate a thriving trading culture.

Prior systems and methods related to commodities trading and the like are described in U.S. Pat. No. 5,903,878 entitled “Method and apparatus for electronic commerce,” U.S. Pat. No. 7,013,289 entitled “Global electronic commerce system,” and U.S. Pat. No. 7,089,199 entitled “System for and method of managing and delivering manufacturer-specified consumer product information to consumers in the marketplace.”

While e-commerce marketplaces host and facilitate the trading of pre-owned goods online, the current online trading options for consumers are difficult, risky and time consuming. Compounding these challenges is the lack of robust tools that help shape informed and profitable decisions for trading in today's secondary marketplaces. In addition, the absence of a transparent trade-in program that is campaign driven and aligned with the consumption of new branded products restricts secondary markets from becoming mainstream. The major obstacles consumers must overcome include: (1) determining a fair market value of pre-owned goods; (2) connecting with the right market to determine which marketplaces represent the greatest opportunity for maximum returns; (3) merchandising ones product to ensure the greatest returns; (4) fielding customer inquiries; (5) internet fraud; and (6) reducing exposure to risk.

Thus, there is a need in the art to develop a sophisticated system and method that will transform the way consumers trade-in and sell pre-owned merchandise.

### SUMMARY

Systems and methods for determining at least one market to sell a trade-in product are disclosed herein.

According to aspects illustrated herein, there is provided a system for determining at least one market to sell a trade-in product including a dynamic pricing guide that determines an initial value for the trade-in product; a product profiler that provides product intelligence; a product profile manager tool that delivers real-time access to product information and collects product information; a trade-in manager tool that accepts, processes and manages the trade-in of the trade-in product; and an automatic merchandising agent for analyzing the product intelligence.

According to aspects illustrated herein, there is provided a method for determining at least one marketplace to sell a trade-in product including acquiring the trade-in product using a trade-in manager tool; inspecting the trade-in product by comparing the trade-in product to product profiles of a product repository; choosing a market price for the trade-in product using an automatic merchandising agent; and determining at least one market to sell the trade-in product.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 is a diagram illustrating the transactions between users and the trader system of the presently disclosed embodiments.

FIG. 2 is a diagram describing a detailed scheme for a trade-in program of the presently disclosed embodiments.

FIG. 3 is a block diagram describing the general scheme for the trade-in program of the presently disclosed embodiments.

FIGS. 4 A-F are flow diagrams describing a detailed scheme for the trade-in program of the presently disclosed embodiments.

FIG. 5 is a flow diagram describing a general scheme for determining the price of a product using a Dynamic Pricing Guide of the presently disclosed embodiments.

FIG. 6 is a diagram describing a detailed scheme for determining the price of a product using the Dynamic Pricing Guide of the presently disclosed embodiments.

FIG. 7 is a flow diagram describing a general scheme for creating repositories of product data using a Product Profiler of the presently disclosed embodiments.

FIG. 8 is a diagram describing a detailed scheme for creating repositories of product data using the Product Profiler of the presently disclosed embodiments.

FIG. 9 is a flow diagram describing a general scheme for determining a site selection and a product placement within a particular marketplace using an Automated Merchandising Agent of the presently disclosed embodiments.

FIG. 10 is a diagram describing a detailed scheme for determining the site selection and product placement within a particular marketplace using the Automated Merchandising Agent of the presently disclosed embodiments.

FIG. 11 is a flow diagram describing a general scheme for syndicating product listings using a Smart Syndicator of the presently disclosed embodiments.

FIG. 12 is a diagram describing a detailed scheme for syndicating product listings using the Smart Syndicator of the presently disclosed embodiments.

FIG. 13 is a diagram displaying how a Rich Internet Application interfaces with the Services Oriented Architecture by first connecting with a Services Layer which routes service calls to the appropriate Business Objects/Models or to a Third Party Systems Service or Applications Programming Interface.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Taking the proven trade-up model platform, so pervasive and accepted in the automotive industry, the presently disclosed embodiments expand this broad concept to selected brands in the durable goods market segments. The trade-up programs of the presently disclosed embodiments will be targeted direct-to-consumers. In addition, by partnering with selected manufacturers and retailers, both big box and individual, trade-up programs may be embedded into the marketing mix. Campaigns may be linked to the marketing and promotion of new products, thus creating a dynamic and sustainable transactional flow. A multi-channel merchandising solution, which provides consumers with a number of dynamic e-commerce tools that inform, instruct and help shape intelligent, wise, and profitable decisions for discerning consumers, is disclosed herein.

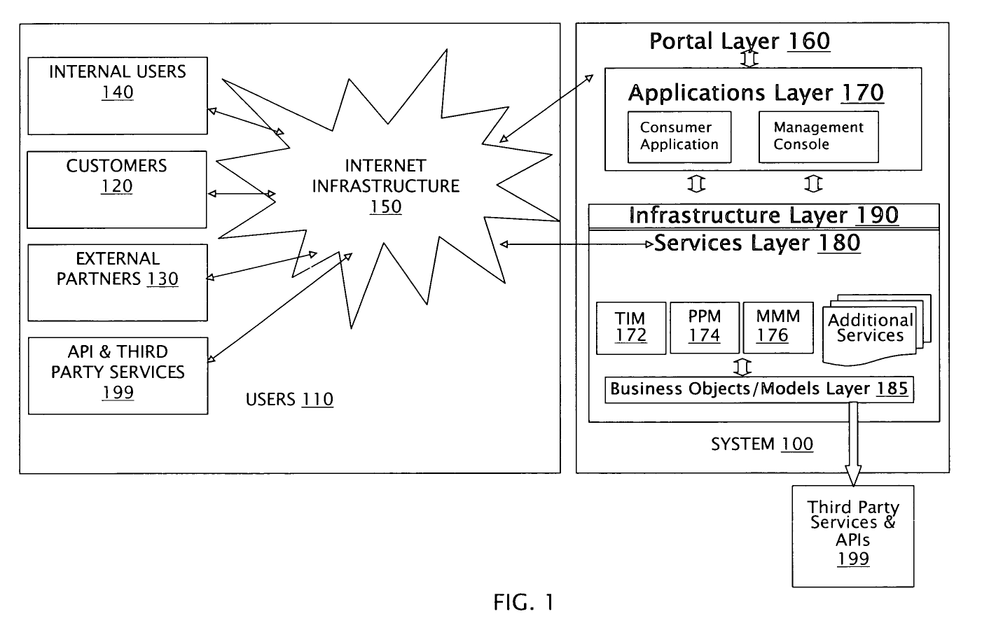

FIG. 1 shows a schematic diagram of a system 100 for trading pre-owned merchandise of the presently disclosed embodiments. Transactions include processing steps taking place between different users 110, namely, customers 120; external partners 130; internal users 140; and Application Programming Interfaces (APIs) and Third Party Services 199, and the system 100. Users 110 may access the system 100 through custom interfaces through a Portal Layer 160, giving the users 110 access and processing power to complete daily tasks. An internet infrastructure 150 between the users 110 and the trader system 100 exists so that the steps required for transactions can be performed properly.

As used herein, “merchandise” and “product(s)” are used interchangeably. The system 100 for trading pre-owned merchandise of the presently disclosed embodiments includes a Portal Layer 160 having an Applications Layer 170, an Infrastructure Layer 190, a Services Layer 180, and a Business Objects/Model Layer 185.

The Portal Layer 160 is a customized portal for users 110 allowing access to the system 100. At a point of login, secure access may be granted based on pre-established permissions of access. Users 110 are required to enter a username and password combination. Once a login attempt is verified, access may be granted to the user 110. Designated Information Technologies personnel are responsible for maintaining all access permissions to the Portal Layer 160. The Portal Layer 160 passes on security information to the Applications Layer 170 such that users 110 can access various services in the Services Layer 180. The Services Layer 180 includes various e-commerce support tools including a Trade-In Manager (TIM) 172, a Product Profile Manager (PPM) 174, and a Multi-Channel Merchandise Manager (MMM) 176.

The Services Layer 180 directs incoming service calls from the Applications Layer 170 to the appropriate internal Business Objects/Model Layer 185 or Application Programming Interfaces (APIs) and Third Party Services 199, shields applications from interface changes by internal or external systems, and provides services deployment flexibility as pointers to internal and external services may easily be changed. The following system-to-system services are available and will be described in detail below: A Dynamic Pricing Guide (DPG); An Automated Merchandising Agent (AMA); A Product Profiler (PP); A Smart Syndicator (SS); An Order Service; A Customer Relationship Manager; Shipping Processing; Business Process Service; Marketplaces; and Payment Processing Services.

The Infrastructure Layer 190 contains business objects and associated logic and data of internal systems. The following commodity software is also contained: Operating System; Database; Database connectivity layer (such as Hibernate or Rails ActiveRecord); Application Server; and Web Server.

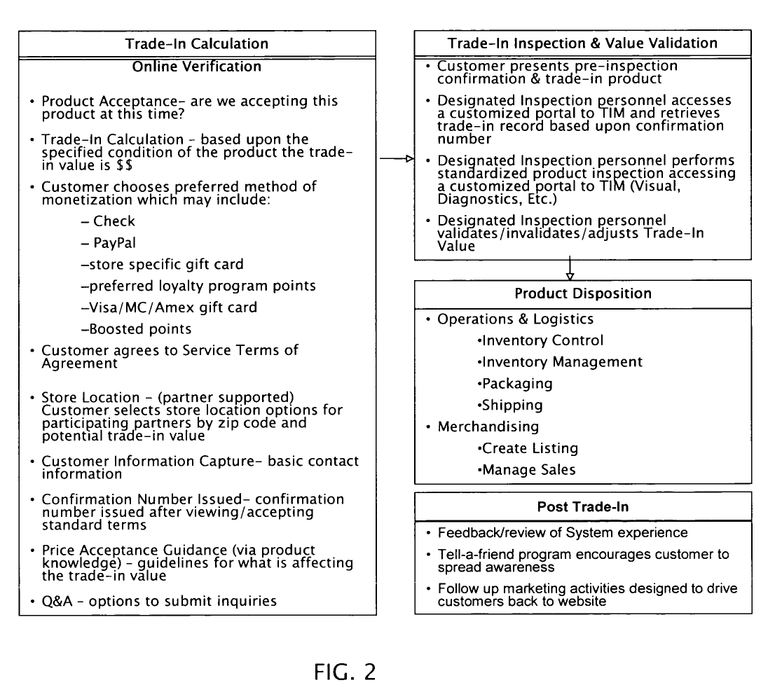

A general trade-in platform process map is shown in FIG. 2 and includes calculating a trade-in value for a product; presenting a trade-in product and a confirmation number to a participating partner for inspection, acquiring by partner network representatives/inspectors a trade-in product; syndicating across multiple online channels the trade-in product to ensure optimal target market exposure; selling the product; and fulfilling orders and product disposition. A post trade-in feedback feature may also exist.

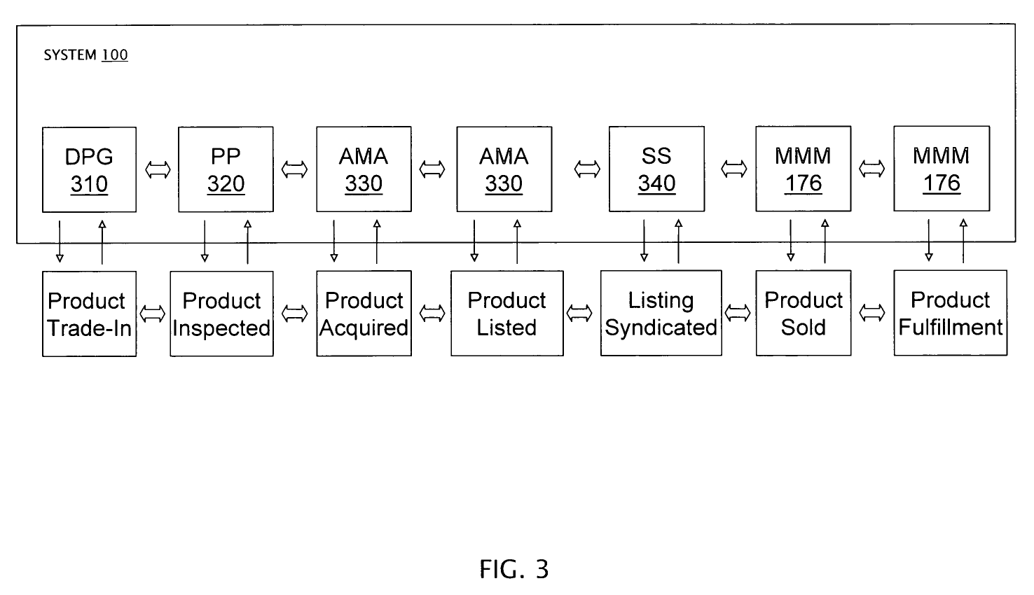

FIG. 3 displays overall business processes mapped to the corresponding systems. The systems are integrated as part of the trade-in platform. A multi-step process illustrates the trade-in cycle from product trade-in through product disposition & fulfillment. FIG. 3 also shows two-way communications between systems and processes.

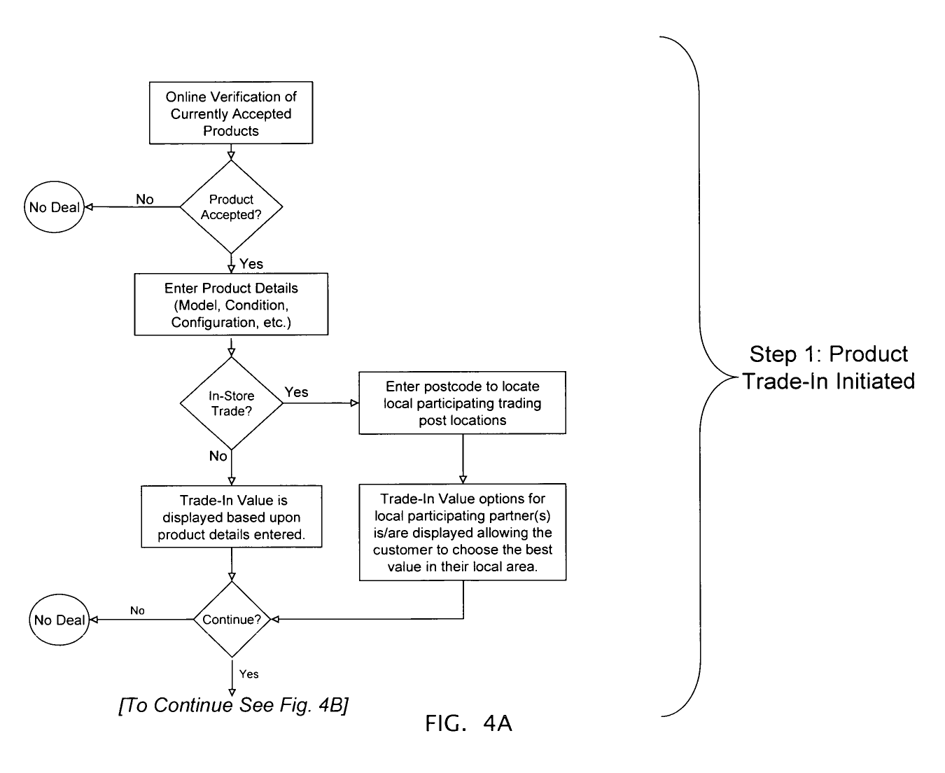

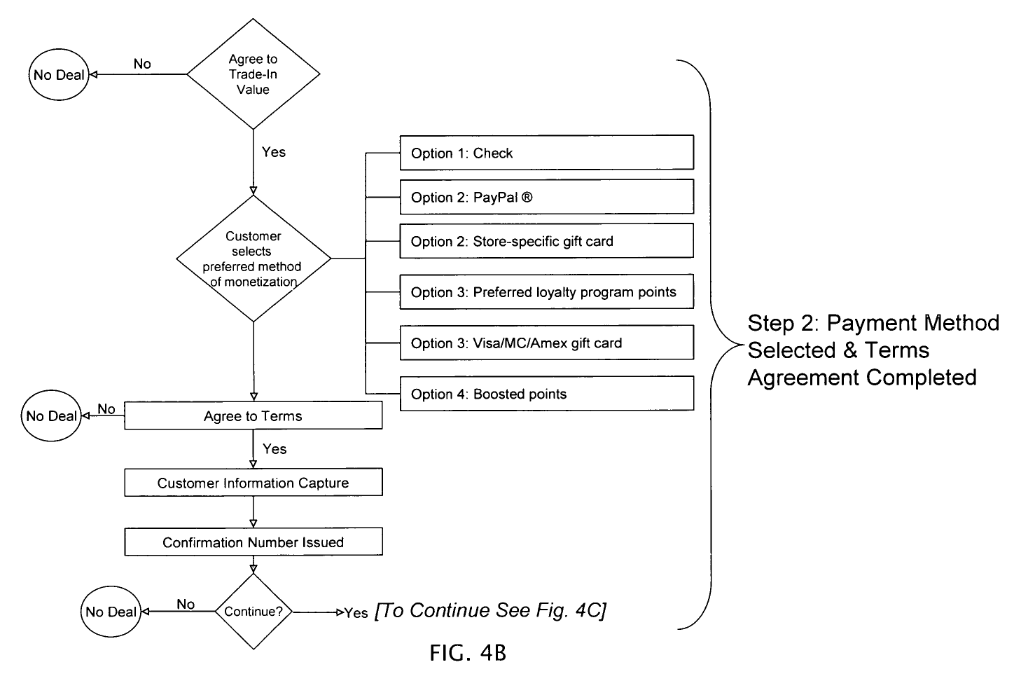

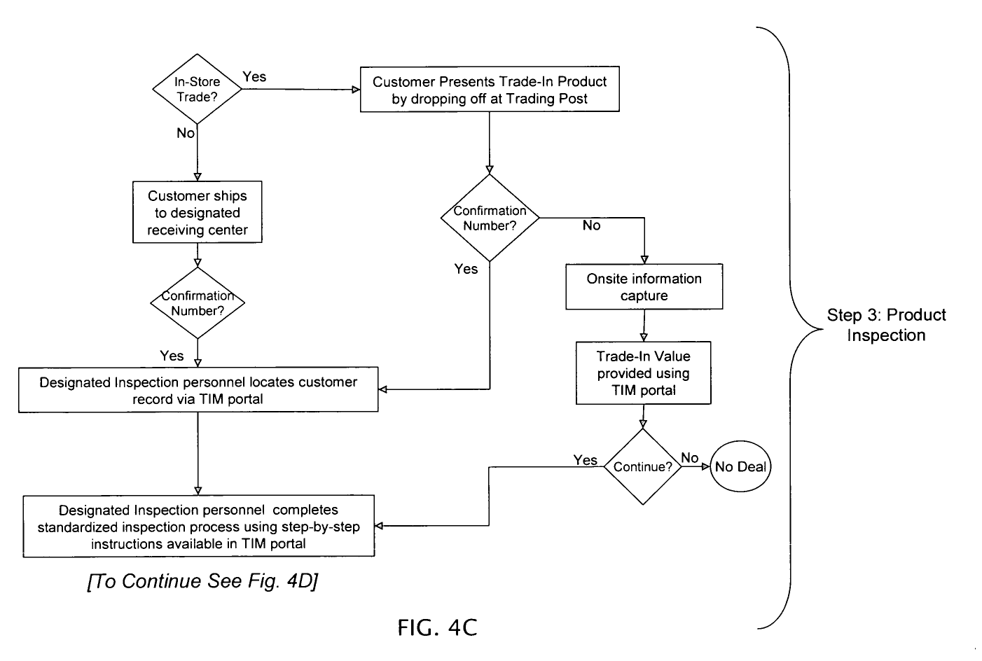

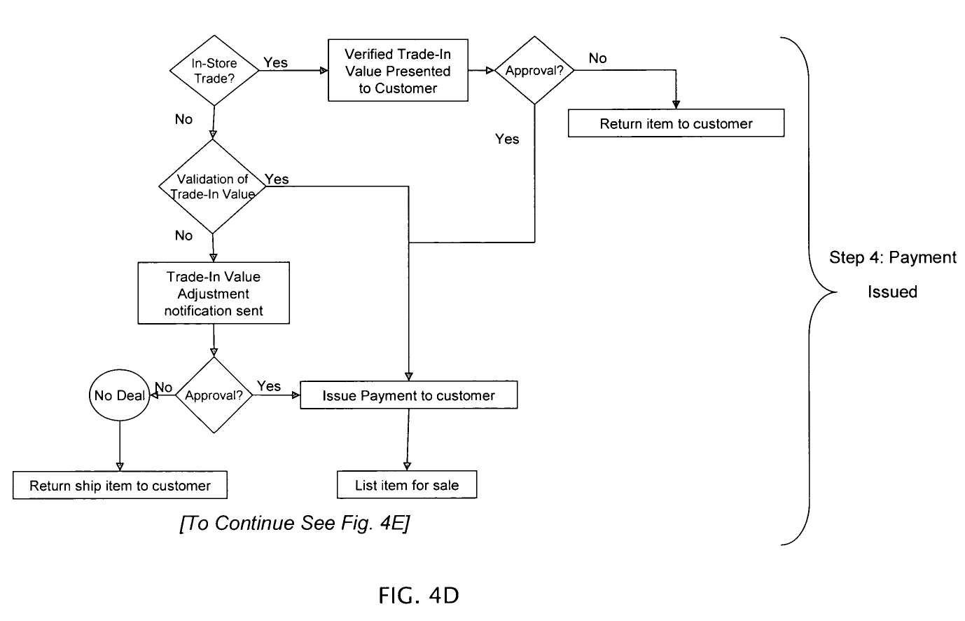

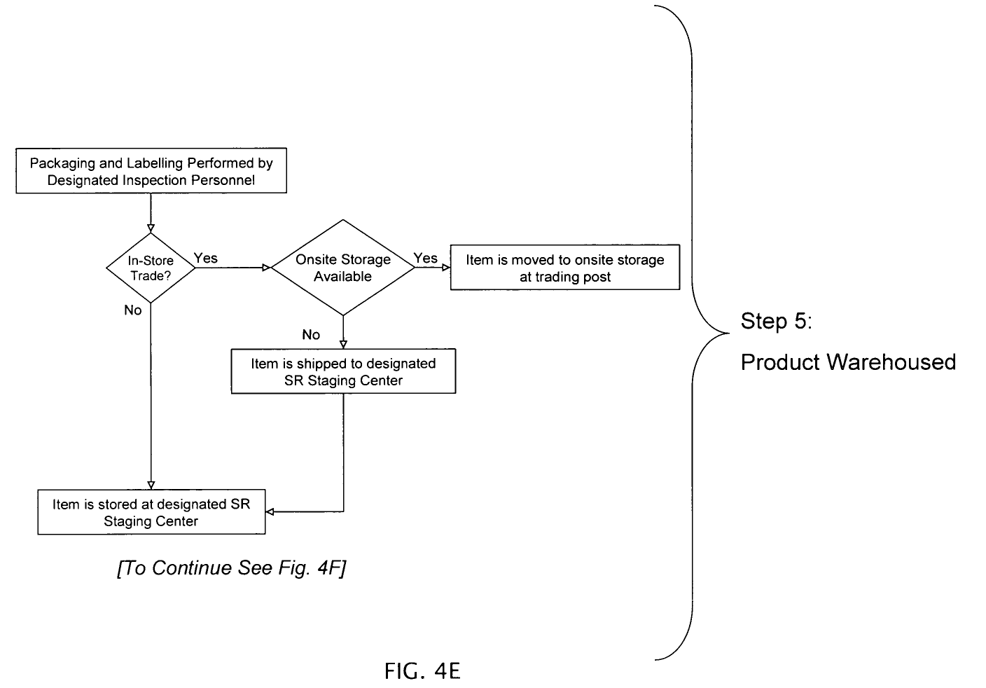

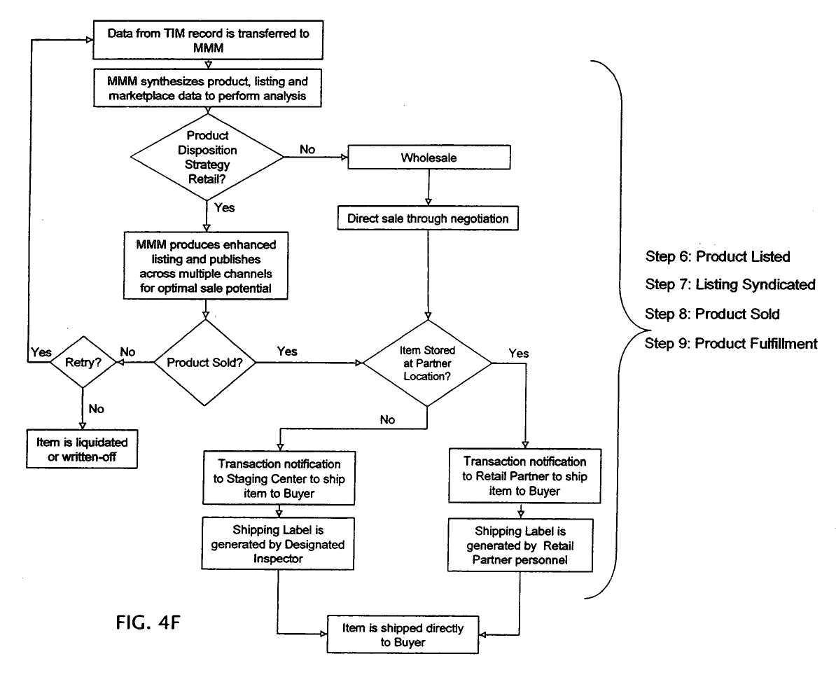

FIG. 3 in conjunction with FIGS. 4A-F shows the trade-in platform process of the presently disclosed embodiments. In step 1, consumers access an easy-to-use website to verify what products are currently accepted, calculate trade-in values, and identify available options to trade-in customer items, either online or through participating partner locations. The easy step-by-step process empowers consumers to realize maximum residual value for their pre-owned merchandise. Step 1 is shown in FIG. 4A. The key technology to enable this process is the Dynamic Pricing Guide (DPG) 310. The DPG 310 determines product trade-in value by retrieving historical information for the product and/or similar products, analyzing the information to create a trade-in value for the product, and returning the value to the user. The DPG 310 will be described in detail below.

In step 2, shown in FIG. 4B, the user agrees to the trade-in value displayed, selects a preferred method for payment and agrees to the terms of the service. A confirmation number is issued in the form of the SR Certificate number.

In step 3, shown in FIG. 4C, the consumer presents a trade-in product and a confirmation number to a designated representative for inspection. The item is inspected to validate or adjust the calculated trade-in value. A standardized step-by-step inspection checklist is provided through a customized portal and guides the representative through the inspection process. The key technology to enable this process is the Product Profiler (PP) 320. The PP 320 aggregates comprehensive product information from a variety of sources to provide a 360-degree view of a product. The PP 320 will apply defined business logic to create a product profile that offers intelligence about a product within the scope of its manufacturer's product line and the product industry segment. The PP 320 will aggregate supporting collateral such as brochure, reference manuals, news (including product recalls, etc.), software updates and downloads, versions, as well as third party related content (blogs, reviews, etc.). Included in the product knowledge are detailed inspection and test procedures to validate that the product is functioning properly. The key benefit from the PP 320 is product intelligence required to support the trade-in of pre-owned goods. Once inspection is complete and adjusted trade-in values, if any, are agreed upon, pre-owned merchandise is now available to be listed and sold in secondary markets.

In step 4, payment is issued to the customer. Payment is determined from the verified trade-in value which is calculated during the inspection process. Payment is issued in the format selected by the customer during Step 2.

During Step 5, the product is warehoused either in-store or at a designated staging center. FIG. 4E illustrates the process for warehousing goods from either in-store or online trade-in programs.

During Step 6, as shown in FIG. 4F, the product is listed for sale in online secondary marketplaces. The key technology enabling this step is the Automated Merchandising Agent (AMA) 330. The AMA 330 integrates key aspects of the PP 320, DPG 210 and the Smart Syndicator (SS) 340 to provide an automated end-to-end solution (from sourcing to selling) for multi-channel eCommerce merchandising. The AMA 330 leverages historical information of current product listings and buyer traffic for each marketplace to enhance and automate the process of product placement in a particular marketplace. The AMA 330 provides dynamic listing and inventory management to enable multi-channel listing from a centralized point. The key benefit from the AMA 330 is automated and intelligent merchandising workflow.

During Step 7, as shown in FIG. 4F, the listing is syndicated across multiple online channels to ensure optimal target market exposure. The key technology to enable this step is the Smart Syndicator (SS) 340. The SS 340 automates the process of intelligently syndicating a product catalog to affiliates and across multiple search engines and marketing services by leveraging data related to product categorization, sales activity, consumer behavior, propensity to buy, click-thru fees, and more. The key benefit from the Smart Syndicator 340 is Cost-Effective Target Market Exposure.

During Step 8, as shown in FIG. 4F, the product is sold to a new buyer through an online marketplace. The key technology to manage and capture information about this step is the Multi-Channel Merchandising Manager (MMM) 176. The MMM 176 manages the collection of metadata regarding the entire sales cycle and updates the inventory system. The MMM 176 also manages product status communications with the Automated Merchandising Agent 330 and Smart Syndicator 340. This notification signals the AMA 330 to remove product listings from marketplaces and the SS 340 to remove product references syndicated across search engines and marketing channels. The MMM 176 continually updates data repositories that feed analytical processes and optimize the entire decision support system.

In step 9, as shown in FIG. 4F, the designated representative fulfills orders. The key technology to enable this step is the MMM 176. The MMM 176 manages the transaction notification to partners and staging center representatives for order fulfillment (i.e. pick, pack and ship). An easy-to-use interface is provided for generating shipping labels to ship items to buyers and closing out the order in the inventory system.

FIG. 4F displays the workflow for post-product acquisition. Once the product has been acquired the system record is passed from the Trade-In Manager to the Multi-channel Merchandising Manager directly or via the inventory systems. Analysis is performed to determine the most appropriate channel for product disposition. The MMM aggregates data related to the product to compile an optimized product listing that will be published across multiple channels. Once the product is sold the MMM notifies retail partners and staging centers of the product status and requests order fulfillment.

FIG. 4F also displays the workflow for post-trade physical product movement. Once the product is acquired it must be stored for the duration of the sales cycle, or until a decision is made to recycle the product. The options for product storage are to store temporarily with the retail partner or at a staging center. Once the product is sold the retail partner is notified with product status and shipping information.

### The Portal Layer (160)

The portal layer 160 is the entry point for both internal users 140 and external partners 130 of the e-commerce tools and manages security and access privileges. The portal layer 160 may be accessed using a standard web browser. Users 110 are required to enter login credentials before system access is granted. After successfully logging in, users 110 are presented with a customized view of the applications (e-commerce tools) they have privileges to run. Users 110 can click on the links provided to launch a specific application from the Services Layer 180. Designated Information Technologies personnel will maintain all access permissions for the Portal Layer 160 and its underlying applications.

### The Services Layer (180)

The Services Layer 180 directs incoming service calls from the Applications Layer 170 to the appropriate Business Objects/Models Layer 185 which interface with internal data repositories or third party services and APIs 199, shields applications from interface changes by internal or external systems, and provides services deployment flexibility as pointers to internal and external services may easily be changed. The following system-to-system services are available and will be described in detail below: The Dynamic Pricing Guide (DPG) 310; The Product Profiler (PP) 320; The Automated Merchandising Agent (AMA) 330; The Smart Syndicator (SS) 340; An Order Service; A Customer Relationship Manager; Shipping Processing; Business Process Service; Marketplaces; and Payment Processing Services.

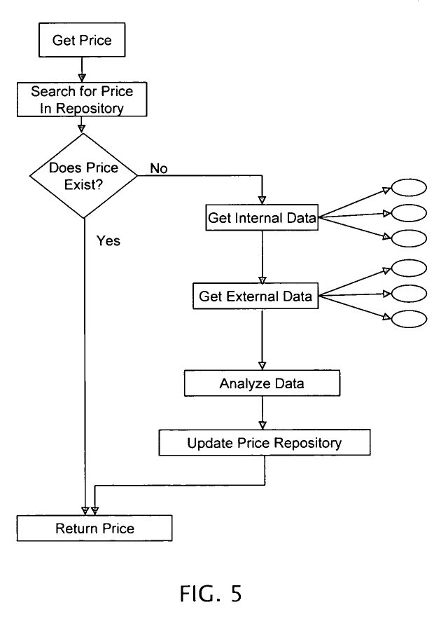

The Dynamic Pricing Guide (DPG) 310 plays an integral role in facilitating the trade-in program. FIG. 5 shows a flow diagram of the general scheme for determining the price of a product using the Dynamic Pricing Guide 310 of the presently disclosed embodiments. FIG. 5 displays the processing engine workflow for the Dynamic Pricing Guide. Input requests initiate a sequence of jobs such as: data lookup, data collection, data analysis and data update. Once this process is complete the requested output is displayed.

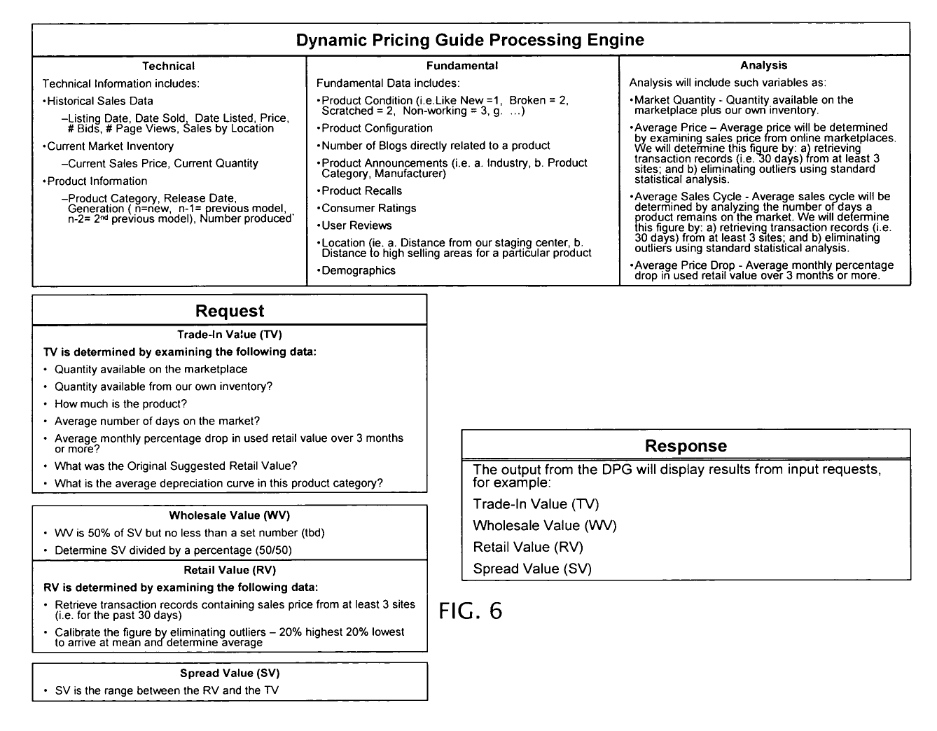

FIG. 6 is a diagram describing a detailed scheme for determining the price of a product using the Dynamic Pricing Guide 310 of the presently disclosed embodiments. Using historical sales data, volume, and marketplace data for merchandise, in conjunction with current product prices and listings, the DPG 310 provides real-time calculation of trade-in prices for products. Prices are continually updated using automated agents that poll eCommerce sites, manufacturers, and other relevant sites for recent pricing information. The DPG 310 may also suggest sale prices for products at marketplaces. The output from the DPG 310 will display results from input requests regarding the Trade-In Value of a product, the Wholesale Value of a product, the Retail Value of a product and the Spread Value of a product.

In order to deliver, to both partners and consumers, one needs to be able to accept, process and manage the trade-in of durable goods. The Trade-In Manager tool 172 provides seamless integration with the marketplace, partners and consumers. The Trade-In Manager tool 172 is built by creating a presentation layer to aggregated services. When possible, the Trade-In Manager tool 172 will be developed as a Rich Internet Application which provide the features and functionality of a traditional desktop application but is accessible using a standard web browser.

The Trade-In Manager tool 172 is designed to enable real-time access to market and product intelligence, trading tools, and resources to ensure the success of the trading process. The process of accepting pre-owned products includes inspecting the pre-owned products; calculating the trade-in value of the merchandise, developing product knowledge of the products; issuing a voucher/coupon for the products; and reporting & analyzing the products. The Trade-In Manager tool 172 uses various technologies including, but not limited to, the Dynamic Pricing Guide 310, an Inspection Guide, and Voucher Issuance Management. The Dynamic Pricing Guide 310 determines product trade-in value by retrieving historical information for the product, analyzing it to create a trade-in value for the product, and returning the value to the user. Trade-in values may be based upon the following data points: average selling price; suggested trade-in value; product lifecycle—where is the product in the product lifecycle; market saturation—what is the quantity of the product available in the marketplace; time on the market—average number of days a product remains on the market; and product condition. A benefit of the Dynamic Pricing Guide 310 is that it provides accurate trade-in values for goods.

The Inspection Guide ensures the quality of trade-in products by providing a product inspection checklist that offers step-by-step instructions on how to inspect products. The product is assigned a scored rating based upon the results of the inspection. A benefit of the inspection guide is that it provides streamlined product inspection.

Voucher issuance management tracks and manages the issuance of a pre-determined value through vouchers or gift cards redeemable through partner store locations or online, providing instant liquidity. Those skilled in the art will recognize that other methods of payment, including PayPal and direct payment via a bank check, are within the scope and spirit of the presently disclosed embodiments.

The product information provided by the Trade-In Manager tool 172 provides well-written product descriptions, feature lists, pictures, videos, and historical product data to assist in the evaluation of products, providing comprehensive product information. Reporting & analysis displays dynamic reporting on trade-in activity and enables drill-through to detail records, providing real-time decision support.

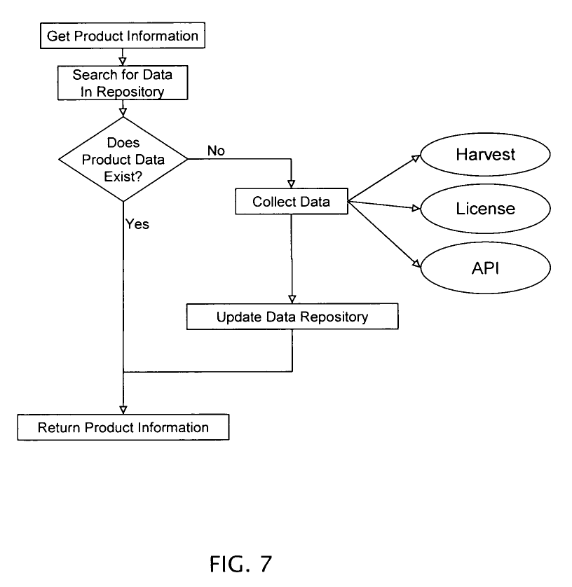

Obtaining a comprehensive view of pre-owned products presents a unique challenge. As manufacturers continue to release new products reliable information for previous iterations of a product becomes difficult to capture or obsolete. This leaves few options for sourcing reliable product information and requires reliance upon on disparate information from potentially unreliable sources. Product descriptions are a key component of selling products online because customers are not able to see, touch, smell or taste products. The customer needs to rely on well-written product descriptions, feature lists, pictures and/or videos to convey the worth of the product. A well-described product can yield a higher purchase price than one that has a lower quality description. A Product Profiler (PP) 320 uses automated agents that continually poll eCommerce, manufacturers, and other relevant sites to create repositories of product data. The Product Profiler (PP) 320 also builds the data repositories from licensed data and data obtained through API calls to third-party websites. FIG. 7 shows a flow diagram describing the general scheme for creating repositories of product data using the Product Profiler 320 of the presently disclosed embodiments. FIG. 7 displays the processing engine workflow for the Product Profiler 320. An input request initiates a sequence of actions, including but not limited to: data lookup, data collection and data update. After the process is complete, the requested output is displayed.

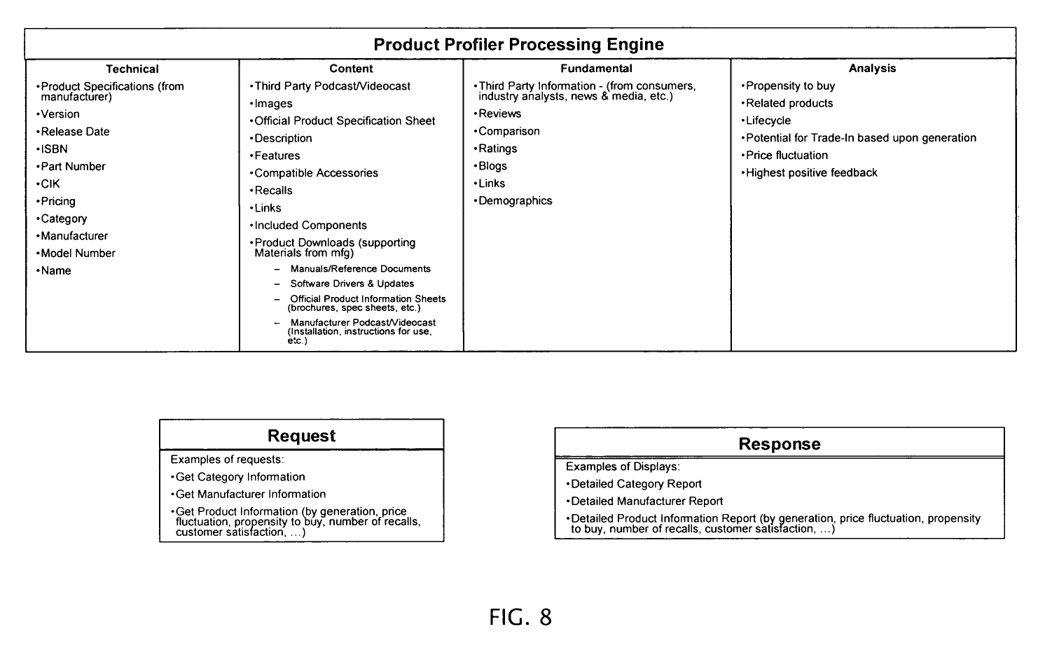

FIG. 8 describes a detailed scheme for creating repositories of product data using the

Product Profiler 320 of the presently disclosed embodiments. Harvested data from several sites can be aggregated to create a comprehensive product profile. When new products are entered, templates are created from the captured repositories. Missing fields are highlighted to assist merchandising personnel to fill out required information. Using automation along with intelligent agents, a Product Profiler Manager tool 174 will eliminate most of the tedious tasks when listing products to marketplaces and provide useful product information to customers. The Product Profile Manager tool 174 is designed to deliver real-time access to product intelligence. The Product Profile Manager tool 174 provides instantaneous access to a massive repository of product information harvested from manufacturer's websites, media files and other online resources.

In addition to aggregating product information, the Product Profile Manager tool 174 applies defined business logic to create a product profile that offers intelligence about a product within the scope of its manufacturer's product line and the product industry segment; and aggregates supporting collateral such as brochure, reference manuals, news (including product recalls, etc.), software updates and downloads, versions, as well as third party related content (blogs, reviews, etc.). The Product Profiler 320 aggregates comprehensive product information from a variety of sources to provide a 360-degree view of a product, providing product intelligence. Presentation templates allow a user to create and manage templates to present all the needed fields when describing the product, providing marketable product descriptions.

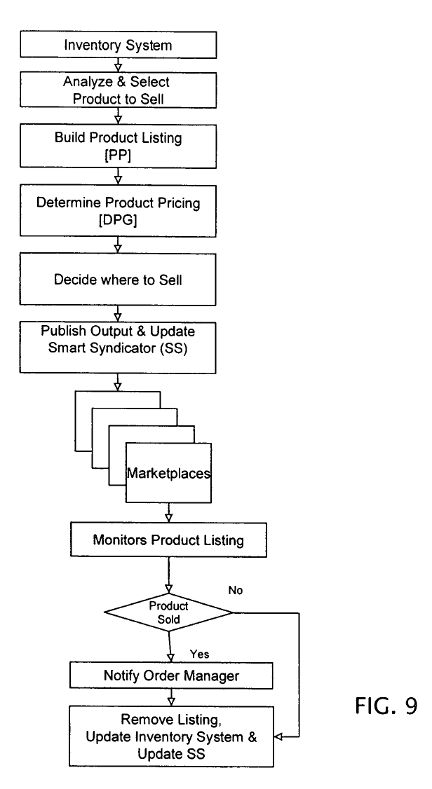

An Automated Merchandising Agent (AMA) 330 intelligently publishes available products across all supported marketplaces. The AMA 330 enables an automated end-to-end solution (from sourcing to selling) for multi-channel eCommerce merchandising, leverages historical information of current product listings and buyer traffic for each marketplace to enhance and automate the process of product placement in a particular marketplace, and provides dynamic listing and inventory management for listing in multiple marketplaces from a centralized point. This provides intelligent merchandising workflow. With multiple channels through which to sell products, the AMA 330 becomes essential to locate the optimal site(s) to increase sales and enhance profit margins. FIG. 9 shows a flow diagram describing the general scheme for determining a site selection and a product placement within a particular marketplace using the Automated Merchandising Agent 330 of the presently disclosed embodiments. The functions of site selection and product placement within a particular marketplace are the responsibility of the AMA 330. Once a product has been added to the product catalog, the AMA 330 may leverage historical information of current product listings and buyer traffic for each marketplace to automate the process of product placement into online marketplaces. To complete the process of managing product placement in multiple marketplaces, the AMA 330 may track the status of a product to ensure that once sold, the product is removed from any remaining marketplace to avoid a product shortage. FIG. 9 displays the processing engine workflow for the Automated Merchandising Agent 330. The AMA 330 analyzes product data from the Inventory System and determines which inventory is available to sell. By leveraging the output of the DPG 310 and the PP 320, the AMA 330 determines product pricing and builds product-listing profiles for optimal marketplace performance. The output of the analysis produces a feed to publish product listings to the marketplace(s) and listing info is sent to the Smart Syndicator 340. If the product is sold the AMA 330 notifies the order manager and removes the product listing from the marketplace(s). As the final step, and to continually optimize decision support, the AMA 330 updates the inventory system and the SS 340 with product listing metadata regarding sales cycle, marketplace performance, ad performance, and more.

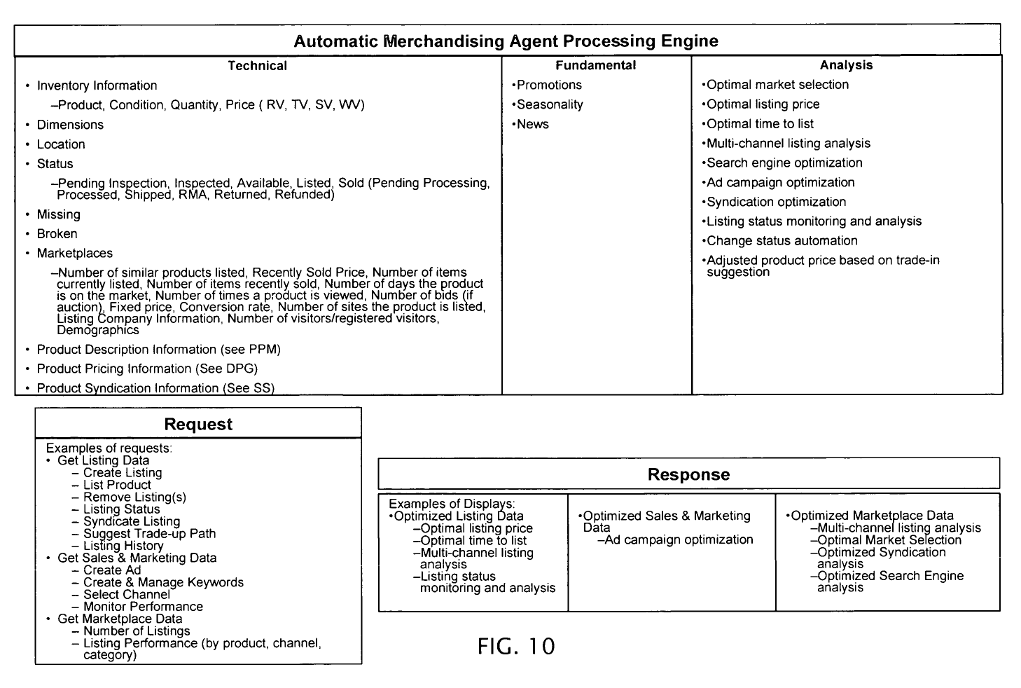

FIG. 10 describes a detailed scheme for determining the site selection and product placement within a particular marketplace using the Automated Merchandising Agent 330 of the presently disclosed embodiments.

The products may be listed in multiple marketplaces as well as third party websites. The Smart Syndicator (SS) 340 provides the ability to publish product listings, whether for buying (published trade-in product profiles) or selling (published ad listings), and create an XML syndication feed (or other format) to all relevant search engines, marketing sites, and any other authorized party interested in the catalog information. The SS 340 automates the process of intelligently syndicating a product catalog to affiliates and across multiple search engines and marketing services by leveraging data related to product categorization, sales activity, consumer behavior, propensity to buy, and click-thru fees, providing cost-effective target market exposure. The product information provides well-written product descriptions, feature lists, pictures, videos, and historical product data to assist in the evaluation of products, providing comprehensive product information. Reporting & analysis displays dynamic reporting on sales, operational and partner activity and enables drill-through to detail records, providing real-time decision support.

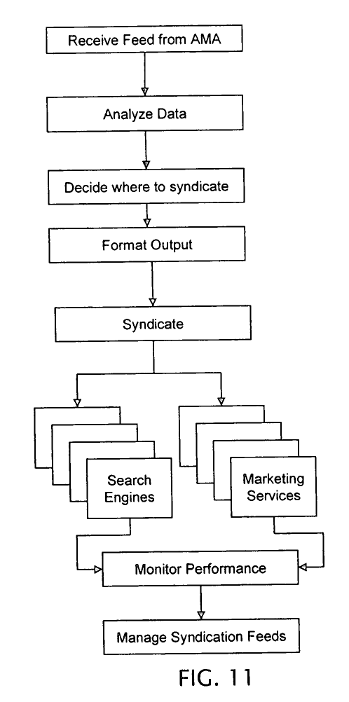

FIG. 11 shows the processing engine workflow for the Smart Syndicator 340. The SS 340 receives a data feed from the AMA 330, conducts analysis to produce output containing properly formatted syndication feeds for trade-in product profiles and purchasing product ad listings and determines where to syndicate. The output is syndicated across multiple marketing sites and search engines to achieve cost-effective target market exposure. The SS 340 monitors ad and listing performance and updates the appropriate data.

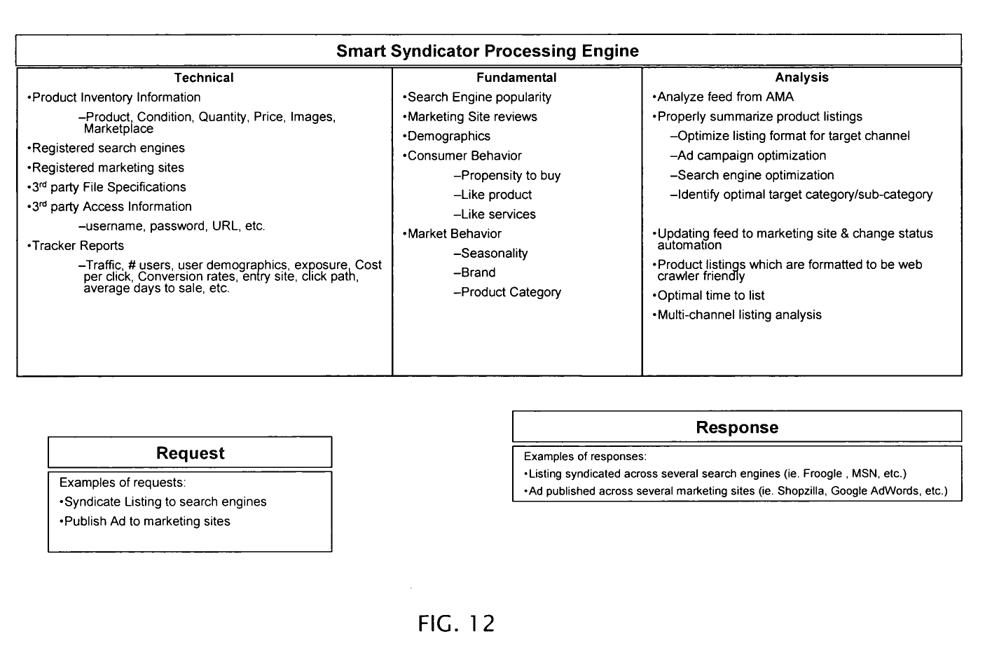

FIG. 12 describes a detailed scheme for syndicating a product across multiple online channels to ensure optimal target market exposure using the Smart Syndicator 340 of the presently disclosed embodiments. In an embodiment, the Smart Syndicator 340 syndicates a product profile for a product that one wishes to sell or trade-in. In an embodiment, the Smart Syndicator 340 syndicates an ad listing for a product that one wishes to purchase.

In order to deliver a multi-channel merchandising solution that eliminates the challenges and frictions of today's eCommerce landscape, a superior end-to-end merchandising application that will streamline the process of dynamically sourcing and selling products across multiple channels is disclosed. The Multi-Channel Merchandising Manager tool 176 provides seamless integration with the marketplace, partners and consumers. The process for automating multi-channel merchandising of durable goods includes determining optimal channel for selling a specific product; assigning selling price for products by channel; creating & managing effective and accurate product descriptions; automatically listing products across multiple channels; creating & managing product listings across multiple channels; dynamically and intelligently syndicating products across multiple search engines and marketing services; and reporting & analyzing. The Multi-Channel Merchandising Manager tool 176 uses various technologies including, but not limited to, the DPG 310, the PP 320, the AMA 330 and the SS 340 (from the Services Layer 180).

An Order Service is part of the additional services that may be provided by the Services Layer 180. The Order Service provides customers with the ability to select products to buy and enter payment and shipping information. Customers are able to add, remove and select quantities of products to a shopping cart. When the order is complete, the customer can check out and enter relevant order information such as payment type, billing info, shipment type, and delivery addresses. The Order Service allows information to be displayed effectively and allows users to easily change and correct any data entry errors. Invalid fields are easily flagged as requiring attention before allowing the user to proceed, making data entry quicker and less error prone.

A Customer Relationship Manager is part of the additional services that may be provided by the Services Layer 180. The Customer Relationship Manager provides functionality that eases the frictions associated with dealing with large volume of customers. The CRM may effectively queue, route, and, as possible, address customer inquiries throughout the lifecycle of a purchase, including post-purchase follow up communication. As needed, the CRM will route communications to the appropriate party responsible for handling the response. Customer-facing users, such as sales representatives and customer care agents, will benefit from an integrated communication lifecycle enabling the system to provide a more personalized experience for the customer. For example, as customers contact the system through any touch point, whether customer care or sales, a 360-degree view of the customer's experience will be instantly available to system personnel. A customer care agent will be informed of the potential sales opportunity or custom agreements that have been established with a customer, allowing a more personalized service to be provided to the customer. Integrating CRM tools with the system will help to eliminate traditional communication barriers of cross-departmental interaction with customers, knowledge of historical activity and general background information made possible by integrating CRM tools with the system. This functionality will be provided by a third party service and will be integrated into the system via the Services Layer 180.

An Executive Management team may be responsible for the strategic direction, health and wealth of the application and services of the presently disclosed embodiments. A Business Process Service will empower the Executive Management Team with a dashboard view of the enterprise designed specifically for the executive-level decision support needs. The Executive Management dashboard will reflect Key Performance Indicators (KPIs) for strategic decision support, including summaries for Inventory, Sales, Partner, Marketplace, and Community. In addition, the Executive Management dashboard will offer drilldown capacity to reveal greater detail on key performance indicators. This functionality will be provided internally and by third party services that will be integrated into the system via the Services Layer 180.

Market Personas hosted by the platform will utilize existing E-commerce solutions such as osCommerce. Market Personas are defined as a subset of an overarching marketplace that assumes a virtual identity and is targeted specifically to the needs of a particular market. By understanding the virtual marketplace at the macro-level, and the unique characteristics of a particular market at the micro-level, the system is prepared to leverage well-defined Market Personas with built-in, automated solutions that address challenges, eliminate frictions and capitalize on eCommerce marketplace opportunities. Customization of the e-commerce solution will be necessary to create the interface with the rest of the services and components of the presently disclosed embodiments. Using this approach, the applications and services of the presently disclosed embodiments may not incur the costs of development for a commodity application.

Transactions of the e-commerce site will be routed to payment processing service providers known in the art, including but not limited to VeriSign and PayPal. Payment processing providers take the information supplied through the marketplaces (i.e. credit card and billing data) and complete the transactions with the credit card companies.

Shipping companies may provide shipping fulfillment and tracking numbers to customers and to internal services. Operations personnel will also print shipping labels for order fulfillment. This functionality will be provided internally and by third party services that will be integrated into the system via the Services Layer 180.

Third party web services provide the ability to access information and interact with the systems of partners including, but not limited to, NetSuite, eBay, Amazon, Channel Advisor, Etilize, Data Unison, CNET, PayPal, Shopzilla and Google. These interfaces will be integrated into the services of the presently disclosed embodiments allowing them to provide increased functionality.

### The Applications Layer (170)

The Applications Layer 170 contains a Management Console that is used by internal users and external partners and a Consumer Application which is used by trade-in customers. These applications provide the user interface and are built by connecting the application with the appropriate services from the Services Layer 180.

The Management Console provides a dashboard for monitoring the health of all applications, services and components running on the Merchandising Platform. Errors, bottlenecks, and service availability will be displayed in an easy-to-use dashboard style Rich Internet Application and will allow IT staff to correct systems issues.

The Consumer Application provides consumers with an easy-to-use interface to the trade-in service. The primary function of the Consumer Application is to broker the necessary interaction between consumers 120 and the Services Layer 180 as required. The Consumer Application shares underlying data with the Management Console within the Applications Layer 170. The Consumer Application is configurable to support a direct-to-consumer strategy or a partner-embedded strategy which leverages a partner's marketing resources and/or physical infrastructure to support the trade-in process.

### The Infrastructure Layer (190)

The Infrastructure Layer 190 contains the Open Stack and related Components for running the trader system 100 such as an operating system, an application server, and a database management system. In an embodiment, the implementation stack used includes: Gentoo Linux as the operating system, Nginx as the web server, Ruby as the scripting/programming language, Mongrel as the application server which runs Ruby on Rails (RoR) applications, and MySQL as the database management system. Ruby On Rails applications use the MVC (Model View Controller) design pattern for separating user interface (View) and data (Model) by using an intermediate component, the Controller.

In an embodiment, the implementation stack used is “LAMP”, a set of software programs commonly used together to run dynamic websites or servers may be used for running the trader system 100. LAMP refers to using Linux as the operating system; Apache as the web server; MySQL, as the database management system; and Perl, PHP, Python, and/or Primate (mod mono) as a scripting/programming language. Currently there are many open source applications built on top of LAMP. The application server provides the ability to build highly scalable and reliable web applications. In an embodiment, the application server is capable of managing Java Enterprise Edition (EE) applications, a standard way of packaging web applications. This standard packaging allows the application to be easily deployed to any Java EE complaint application server. The trader system 100 may utilize relational database technology to store specific metadata needed to run the services. Information such as inventory, customer information, campaigns, price, etc. may either be stored in a database, or calculated from information in the database.

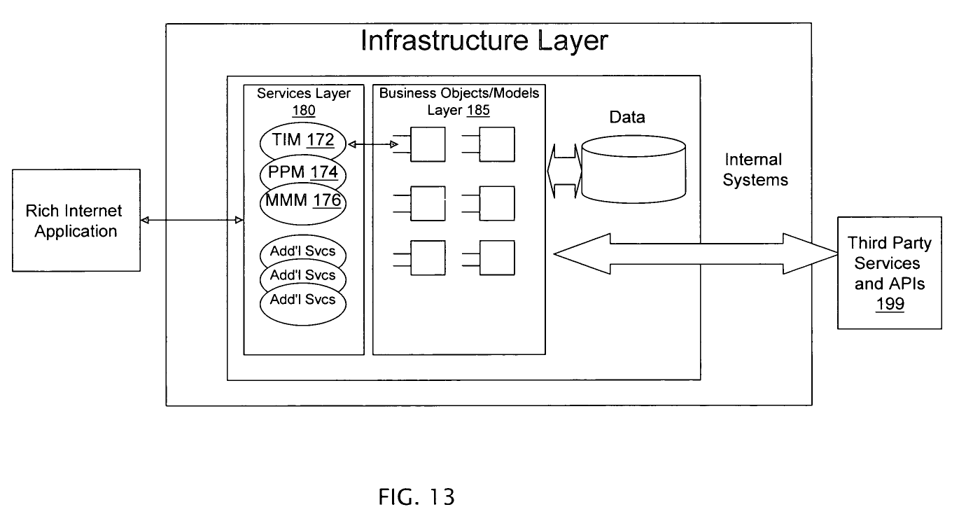

FIG. 13 is a diagram showing how a Rich Internet Application (RIA) interfaces with the Services Oriented Architecture by first connecting with the Services Layer 180 which routes service calls to the appropriate Business Objects/Models Layer 185 or to Third Party Systems 199. A RIA serves as the user interface layer to the rest of the system's 100 services and data. The Services Layer 180 communicates with the Business Objects/Models Layer 185 to retrieve, update, and insert data and routes responses back to the RIA through the Services Layer 180. This architecture shields RIAs from the Service's implementation and underlying business object/model classes and promotes code reuse because services can be used by several different RIAs.

Internet Application Stack may be utilized in the applications (tools) and services of the presently disclosed embodiments. By utilizing services provided via open standards based architecture, including XML, Web Services, and HTTP, applications are built easily and efficiently and are able to provide a host of new services. As new features are required, new services may easily be built and incorporated into existing applications. With open standards as the foundation, the system of the presently disclosed embodiments may be able to provide the services required in a cost-effective and efficient manner. Well-defined services enhance the platform's advantage by protecting front-end applications from technology choices and third party services that require complex integration to deliver needed functionality.

With the flexibility of the systems Service Oriented Architecture the user interface may need to be equally as flexible. Rich Internet Applications (RIAs) provide the ability to build complex composite applications that may be developed to meet the needs of platform users. RIAs have the feel and responsiveness of desktop applications yet do not require complex installation programs and are easily updateable. RIAs can be accessed using a standard browser and may use programming methodogies such as AJAX (Asynchronous Javascript And XML) to increase the perceived responsiveness of the application.

An Eclipse Integrated Development Environment (IDE) provides the software framework for developers to create application source code for both backend services and front-end applications. Ruby on Rails applications and services can be developed with the Eclipse IDE. Eclipse includes compilers, text editors, plugins and debuggers needed for developing applications. Eclipse is open source and is provided by third party vendors.

A Flex Rich Internet Application Framework from Adobe Systems Inc. provides the needed user interface functionality to handle the complex data presentation and interactions of the services. With the ability to deliver desktop style applications via the Internet, Flex will eliminate the cost of maintaining an installed user base without sacrificing functionality. Users can run Flex applications using a standard browser and are not required to run installation programs to use the software. Flex is commercial software and is provided by third party vendors.

A Portal/Content Management Systems (CMS) is a web application used for managing websites and web content. Many CMS frameworks (such as Joomla) are open source and allow the creation of custom web portals which provide easily deployed features such as wikis, blogs, and forums. Once installed, CMS allow authorized non-technical users to add or edit content, update images, and manage data on a website. CMS also provide the ability to install additional add-ons and extensions to enhance functionality. CMS may be configured as a single gateway for employees, customers and partners to access a company's information, applications and services. CMS systems are commercial and open source and are provided by third party vendors.

Subversion is a revision control system for managing changes in source code. Developers can safely make program changes, create versions of files and releases with the ability to revert to earlier editions. Subversion tracks all changes made to source code, allows developers to add comments, and provides the ability to highlight changes between versions. As long as all source files are checked into Subversion properly, an application or software service can be recreated using the applicable IDE. Subversion is open source and is rapidly replacing traditional CVS repositories. Subversion and associated tools are provided by third party vendors.

A system for trading-in and selling merchandise includes a services layer having a dynamic pricing guide that determines a trade-in price for the merchandise, a product profiler for providing merchandise intelligence for the trade-in of merchandise, an automated merchandising agent for building and listing merchandise profiles for optimal marketplace performance, and a smart syndicator for syndicating the merchandise profiles across multiple online channels; and an applications layer having a trade-in manager tool that accepts, processes and manages the trade-in of the merchandise, a product profile manager tool providing real-time access to product intelligence, and a multi-channel merchandising manager tool for sourcing and selling of merchandise across a plurality of marketplaces.

The dynamic pricing guide receives a request for obtaining information about the merchandise; retrieves information for the merchandise; analyzes the information to create a trade-in value for the merchandise; and displays the trade-in value for the merchandise.

The product profiler collects data from a plurality of sites; aggregates the data to create a comprehensive merchandise profile; creates repositories of merchandise data; and places the repositories of merchandise data in a presentation template. The product profiler uses automated agents that poll eCommerce, manufacturers, and other relevant sites to create the repositories of merchandise data. The product profiler aggregates comprehensive merchandise information from a variety of sources to provide a 360-degree view of the merchandise.

The automated merchandising agent analyzes merchandise data from an inventory system and determines which inventory is available to sell; determines merchandise pricing; builds merchandise-listing profiles for optimal marketplace performance; selects the marketplace and produces a data feed to publish product listings to the marketplace.

The smart syndicator receives a data feed of merchandise-listing profiles from the automated merchandising agent; analyzes the data feed of merchandise-listing profiles to produce a product catalog output containing formatted syndication feeds and ad listings; and syndicates the product catalog output across multiple marketing sites and search engines for cost-effective target market exposure.

The trade-in manager 172 provides a real-time calculation of trade-in price of the merchandise. The system includes eCommerce sites, manufacturers, and other relevant sites for pricing information about the merchandise using an automated agent. The system includes notifying an order manager and removing the merchandise listing from the marketplace and inventory system once the merchandise has been sold. The system includes updating the inventory system with merchandise listing metadata regarding sales cycle, marketplace performance, and ad performance. The system includes monitoring ad listings and listing merchandise-listing profile performance to update the appropriate data feed. The trade-in manager tool enables real-time access to market and merchandise intelligence, trading tools, and resources. The multi-channel merchandising manager tool manages the collection of metadata regarding sales cycle, marketplace performance, and ad performance. A portal layer allows access to the system.

The processing performed by the system described herein may be performed by a general purpose computer alone or in connection with a specialized processing computer. Such processing may be performed by a single platform or by a distributed processing platform. In addition, such processing and functionality can be implemented in the form of special purpose hardware or in the form of software being run by a general purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

A method for determining at least one marketplace to sell a trade-in product includes acquiring the trade-in product using a trade-in manager tool; inspecting the trade-in product by comparing the trade-in product to product profiles of a product repository; choosing a market price for the trade-in product using an automatic merchandising agent; and determining at least one market to sell the trade-in product.

All patents, patent applications, and published references cited herein are hereby incorporated by reference in their entirety. It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for determining at least one market to sell a trade-in product comprising:
a dynamic pricing guide that determines an initial value for the trade-in product;
a product profiler that provides product intelligence;
a product profile manager tool that delivers real-time access to product information and collects product information;
a trade-in manager tool that accepts, processes and manages the trade-in of the trade-in product; and
an automatic merchandising agent for analyzing the product intelligence.

2. The system of claim 1 wherein the dynamic pricing guide determines an initial value of the trade-in product by: obtaining general information about the trade-in product; retrieving published information about the product; comparing the published information to the general information; and analyzing the published information to determine an initial value for the trade-in product.

3. The system of claim 1 wherein the product profile manager tool collects information about the trade-in product from a plurality of sites; aggregates the information to create a trade-in product profile; and creates a product repository.

4. The system of claim 3 wherein the product profile manager tool collects information about the trade-in product by polling eCommerce, manufacturers, and other relevant sites to create the product repository.

5. The system of claim 1 wherein the product profile manager tool uses licensed data and data obtained through application programming interface calls to third-party websites to create the product repository.

6. The system of claim 1 wherein the product profiler manager tool applies defined business logic to create the product repository within the scope of a manufacturer's product line and the trade-in product industry segment.

7. The system of claim 1 wherein the product profile manager tool aggregates supporting collateral such as brochure, reference manuals, news, software updates and downloads, versions, and third party related content to create the product repository.

8. The system of claim 1 wherein the automatic merchandising agent determines at least one market to sell the trade-in product by leveraging output from the dynamic pricing guide and the product profiler.

9. The system of claim 1 wherein the automatic merchandising agent provides dynamic listing and inventory management to enable multi-channel listing from a centralized point.

10. The system of claim 1 wherein the trade-in manager tool uses various technologies to accept, process and manage the trade-in of the trade-in product.

11. The system of claim 10 wherein the various technologies include the dynamic pricing guide, an inspection guide, and voucher issuance management.

12. A method for determining at least one marketplace to sell a trade-in product comprising:
acquiring the trade-in product using a trade-in manager tool;
inspecting the trade-in product by comparing the trade-in product to product profiles of a product repository;
choosing a market price for the trade-in product using an automatic merchandising agent; and
determining at least one market to sell the trade-in product.

13. The method of claim 12 wherein the trade-in manager tool accepts, processes and manages the trade-in of the trade-in product.

14. The method of claim 12 wherein the product profiles of the product repository are created by collecting information about the trade-in product from a plurality of sites.

15. The method of claim 14 wherein the information is collected by polling eCommerce, manufacturers, and other relevant sites to create the product repository.

16. The method of claim 14 wherein the product profiles are created by using licensed data and data obtained through application programming interface calls to third-party websites.

17. The method of claim 14 wherein the product profiles are created by applying defined business logic within the scope of a manufacturer's product line and the trade-in product industry segment.

18. The method of claim 14 wherein the product profiles are created by aggregating supporting collateral such as brochure, reference manuals, news, software updates and downloads, versions, and third party related content.

19. The method of claim 12 wherein the automatic merchandising agent determines at least one market to sell the trade-in product by leveraging output from the dynamic pricing guide and the product repository.

20. The method of claim 12 wherein the automatic merchandising agent provides dynamic listing and inventory management to enable multi-channel listing from a centralized point.
